(19) United States
(12) Patent Application Publication
(10) Pub. No.: US 2023/0136531 A1
(43) Pub. Date: May 4, 2023

(54) GATE / DOOR HINGE APPARATUS AND METHOD OF USE FOR INSTALLATION, ADJUSTMENT, AND MAINTAINING ALIGNMENT

(71) Applicant: Richard Alarcon, Lakewood, CA (US)

(72) Inventor: Richard Alarcon, Lakewood, CA (US)

(21) Appl. No.: 17/381,186

(22) Filed: Jul. 20, 2021

(51) Int. Cl. E05D 7/04

(52) U.S. Cl. CPC E05D 7/0423; E05D 2007/0469; E05Y 2201/70; E05Y 2600/12; E05Y 2600/312; E05Y 2600/45; E05Y 2600/46; E05Y 2900/40

(57) ABSTRACT

A gate hinge apparatus and method adapted to be fastened to a vertical gate and to a post, comprising: a L-bolt having an elongated horizontal portion formed with thread and a transition into a vertical male member; a first bracket having a female mounting flange mounted to either the gate or the post disposed adjacent to the gate as elected by said user; a second bracket having a plate having one or more threaded means for holding and retaining said L-bolt, which is mounted to the gate or the post disposed adjacent to the gate; said L-bolt uses its vertical male member to connect to said female mounting flange; and said L-bolt has one or more nuts that are positioned on said thread on said elongated horizontal portion of said L-bolt to adjust said hinge. The method comprising: rotating the nut in a first angular direction to increase the gap width; and rotating the bolt in a second angular direction, to decrease the gap width.

### CROSS-REFERENCE TO RELATED APPLICATIONS

The present application claims priority under 35 U.S.C. 119(e) and under all applicable U.S. statutes and regulations, to U.S. Provisional Application Ser. No. 63/054,233 filed Jul. 20, 2020. The disclosure of which is hereby incorporated herein by reference in its entirety.

### FIELD OF THE INVENTION

The present invention relates to Gate and/or Door Hinges consisting of a male and female member that can be quickly and easily installed, adjusted and maintained in alignment and a method of using the apparatus.

### BACKGROUND OF THE INVENTION

Gates and/or Doors are usually hung using at least two hinges. A standard hinge includes two hinge leaves, which are commonly flat metal plates, each hinge leaf including one or more cylinders adapted to interfit with the cylinders on the opposite leaf such that a hinge pin may be slid down the center of the cylinders to secure the hinge leaves to one another. One of the hinge leaves is then secured to the gate/door jamb while the opposite hinge leaf is secured to the gate/door, thus allowing the gate/door to pivot about the hinge pin in the hinge.

While a standard hinge as described above is useful in many gate/door hanging situations, several problems encountered in hanging gates/doors cannot be addressed by using the standard hinge. Most importantly, the standard hinge does not provide any means by which adjustment of the gate/door swing may be effected. Adjustments to the gate/door hinge alignment are mandated by swelling, shrinking or warping of the gate/door frame member or door jamb to which the hinge is connected. Warping of the gate/door frame may also be caused by settling of the foundation in newer houses. There is therefore a need for a door hinge alignment apparatus which is capable of slight adjustment of the gate/door swing position.

It is an object of the present invention is to provide an improved gate/door hinge alignment apparatus.

Additionally, there is a need in the art for a new apparatus for gates/door hinges consisting of a male and female member that can be quickly and easily installed, adjusted and maintained in alignment and a method of using the apparatus

Further, there is a need in the art for a new method for installing gates/door hinges.

Furthermore, there is also a need in the art for a new method for adjusting gates/door hinges.

Lastly, there is another need in the art for a new method for maintaining in alignment gates/door hinges.

It is therefore a general object of the present invention to provide an improved gate/door hinge consisting of a male and female member that can be quickly and easily installed, adjusted and maintained in alignment.

### SUMMARY OF THE INVENTION

It is an object of this invention is to provide a gate/door hinge consisting of a male and female member that can be quickly and easily installed, adjusted and maintained in alignment.

It is another object of this invention to provide a gate/door hinge having a screw for adjusting the hinged members relatively toward or away from one another.

It is also an object of the present invention is to provide an improved gate/door hinge alignment apparatus.

It is also an object of the present invention is to provide a new method for installing gates/door hinges.

It is another object of the present invention is to provide a new method for adjusting gates/door hinges.

It is still yet another object of the present invention is to provide a new method for maintaining in alignment gates/door hinges.

Another object of the present invention is to provide a gate/door hinge apparatus adapted to be fastened to vertical gate post comprising: a first L-bolt (10) having an elongated horizontal portion formed with thread (42) and a transition into a vertical male member (44); a first bracket (35) having a female mounting flange (46) mounted to either the gate or the post disposed adjacent to the gate as elected by said user; a second bracket (40) having a plate (47) having one or more threaded means for holding and retaining (48) said L-bolt, which is mounted to the gate (20) or the post (22) disposed adjacent to the gate (20); said L-bolt (10) uses its vertical male member (44) to connect to said female mounting flange (46); said L-bolt (10) has one or more nuts (70) that are positioned on said thread (42) on said elongated horizontal portion of said L-bolt (10) to adjust said hinge (100); wherein a user can by rotating the nut in a first angular direction to increase the gap width; and wherein said user can by rotating the nut in a second angular direction, opposite of the first angular direction, to decrease the gap width.

It is an object of this invention to create a new gate/door hinge apparatus that is easy to manufacture, reliable in operation, and relatively inexpensive to produce.

In addition to the above objects, various other objects of this invention will be apparent from careful reading of this specification including the detailed description contained herein below.

### BRIEF DESCRIPTION OF THE DRAWINGS

These as well as other features of the present invention will become more apparent upon reference to the accompanying drawings wherein like numerals designate corresponding parts in the several figures summarized as follows:

FIG. 1 is a perspective view of the preferred embodiment of the invention having a nut for adjusting said hinge.

FIG. 2 is a back view of the preferred embodiment of the invention having a nut for adjusting said hinge.

FIG. 3 is a top view of the preferred embodiment of the invention having a nut for adjusting said hinge.

FIG. 4 is a side view of the preferred embodiment of the invention having a nut for adjusting said hinge.

FIG. 5 is a perspective view of the preferred embodiment of the invention having a nut for adjusting said top hinge and said bottom hinge.

FIG. 6 is a perspective view of the preferred embodiment of the invention having a nut and adjusting said top hinge and said bottom hinge from the position in FIG. 5.

FIG. 7 is a perspective view of an embodiment of the invention having a nut for using the Allen Wrench to adjusting said hinge.

FIG. 8 is a back view of an embodiment of the invention having a nut for using the Allen Wrench for adjusting said hinge.

FIG. 9 is a top view of an embodiment of the invention having a nut for using the Allen Wrench for adjusting said hinge.

FIG. 10 is a side view of an embodiment of the invention having a nut for using the Allen Wrench for adjusting said hinge.

FIG. 11 is a perspective view of an embodiment of the invention having a nut for using the Allen Wrench for adjusting said top hinge and said bottom hinge.

FIG. 12 is a perspective view of the preferred embodiment of the invention having a nut for using the Allen Wrench and adjusting said top hinge and said bottom hinge from the position in FIG. 11.

FIG. 13 is a perspective view of another embodiment of the invention having an L-Shaped Bolt for adjusting said hinge.

FIG. 14 is a front view of another embodiment of the invention having a L-Shaped Bolt for adjusting said hinge.

FIG. 15 is a perspective view of another embodiment of the invention having a L-Shaped Bolt for adjusting said top hinge and said bottom hinge.

FIG. 16 is a perspective view of another embodiment of the invention having a L-Shaped Bolt and adjusting said top hinge and said bottom hinge from the position shown in FIG. 15.

FIG. 17 is a perspective view of another embodiment of the invention having nuts for adjusting said hinge.

FIG. 18 is a front view of another embodiment of the invention having nuts for adjusting said hinge.

FIG. 19 is a perspective view of another embodiment of the invention having nuts for adjusting said top hinge and said bottom hinge.

FIG. 20 is a perspective view of another embodiment of the invention having nuts for adjusting said top hinge and said bottom hinge from the position shown in FIG. 19.

Other features and advantages of the invention will be become apparent from the following detailed description, taken in conjunction with the accompany drawings, which illustrate, by way of example, various features of the invention.

### DETAILED DESCRIPTION OF THE PREFERRED EMBODIMENTS

The following detailed description and accompanying drawings are provided for purposes of illustrating and describing presently preferred embodiments of the present invention and are not intended to limit the scope of the invention in anyway. It will be understood that various changes in the details, materials, arrangements of parts or operational conditions which have been herein described and illustrated in order to explain the nature of the invention may be made by those skilled in the art within the principles and the scope of the invention.

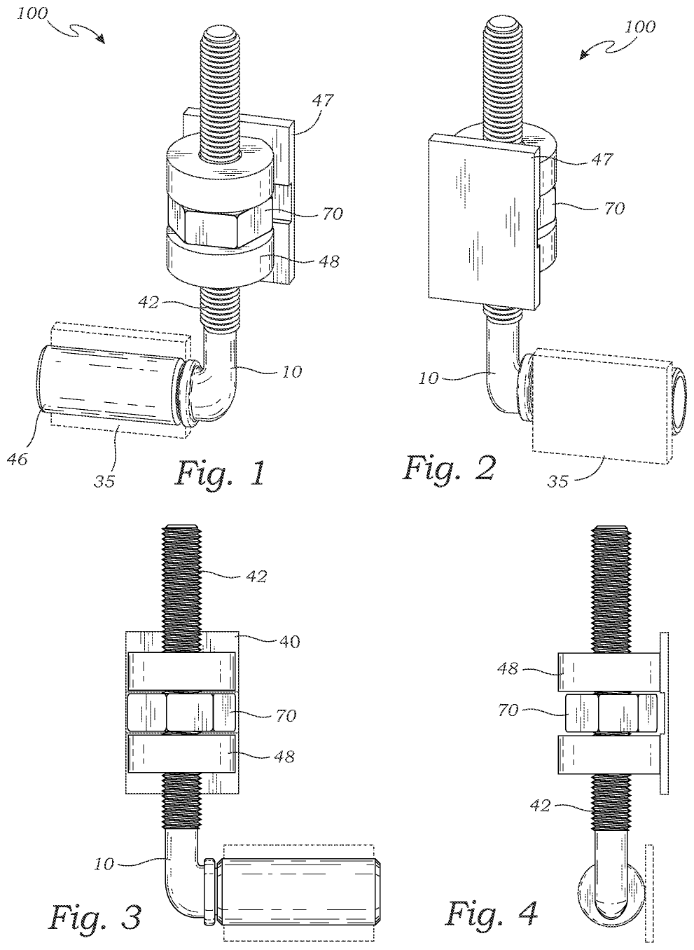

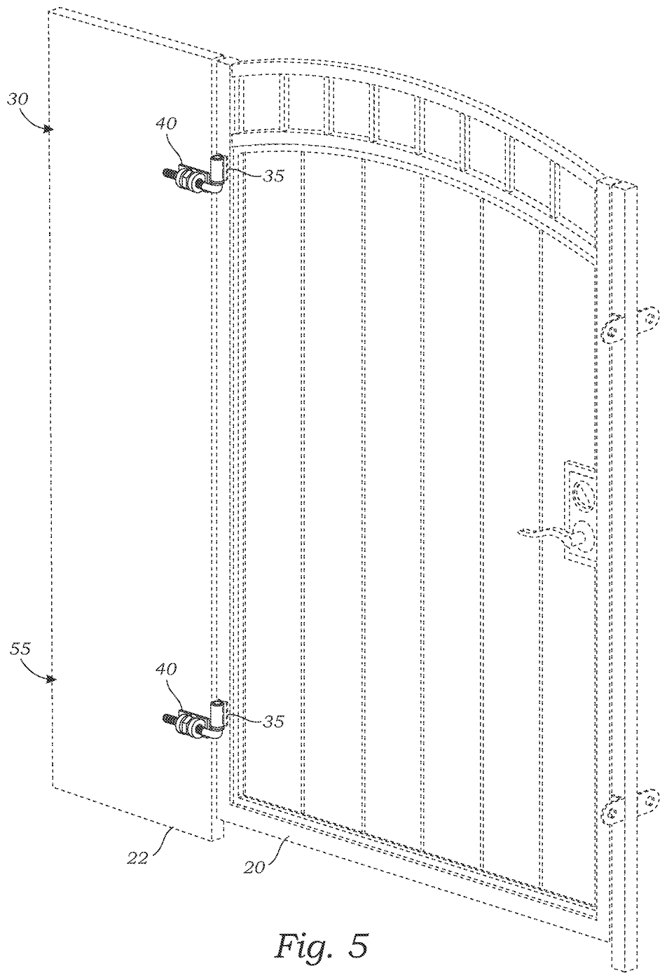

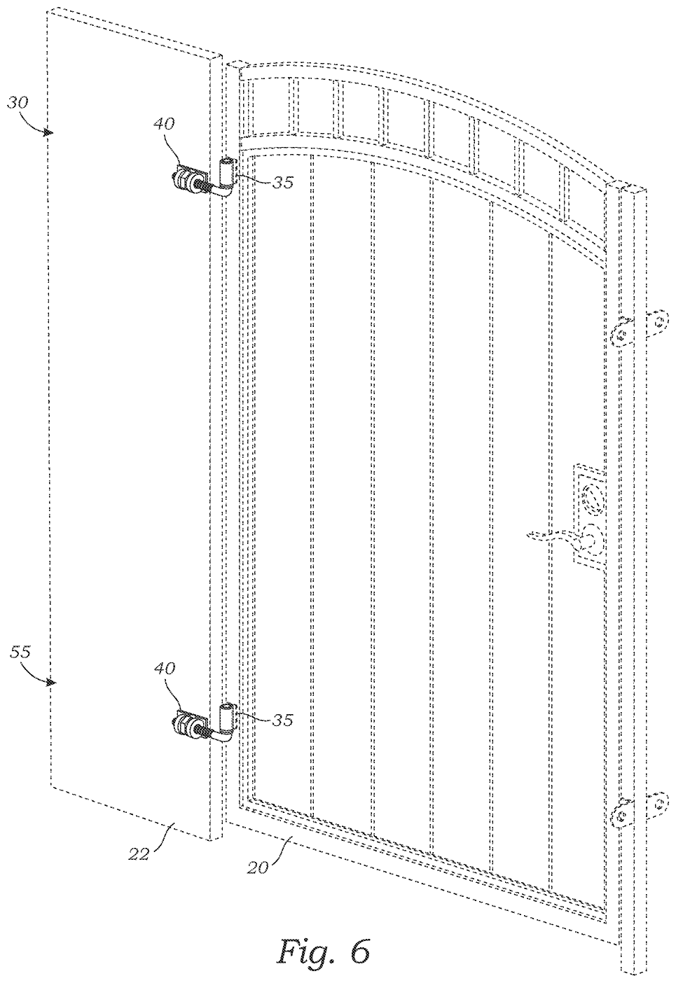

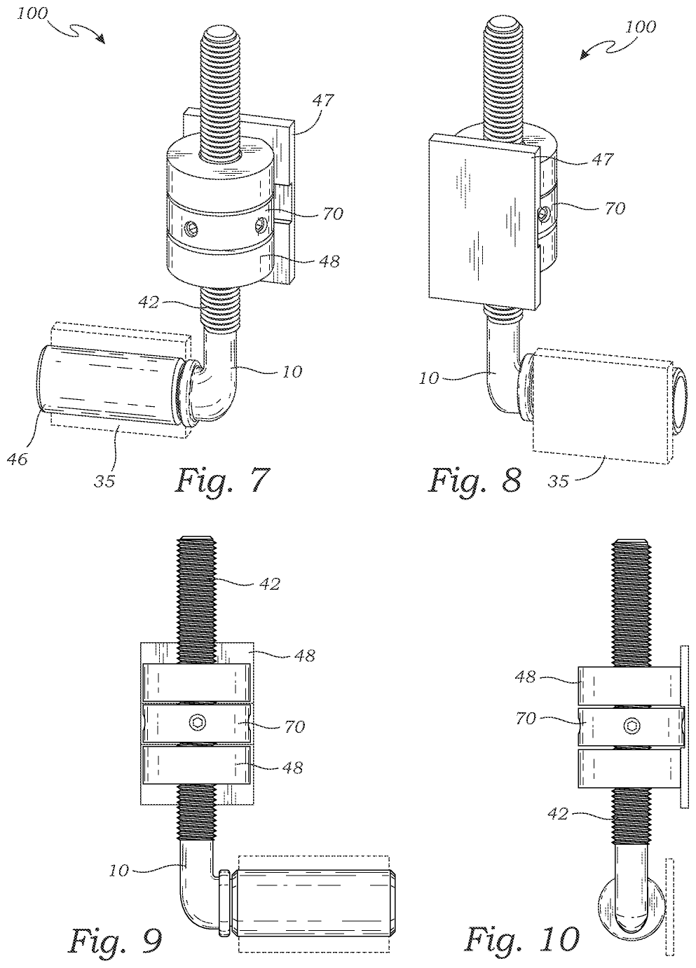

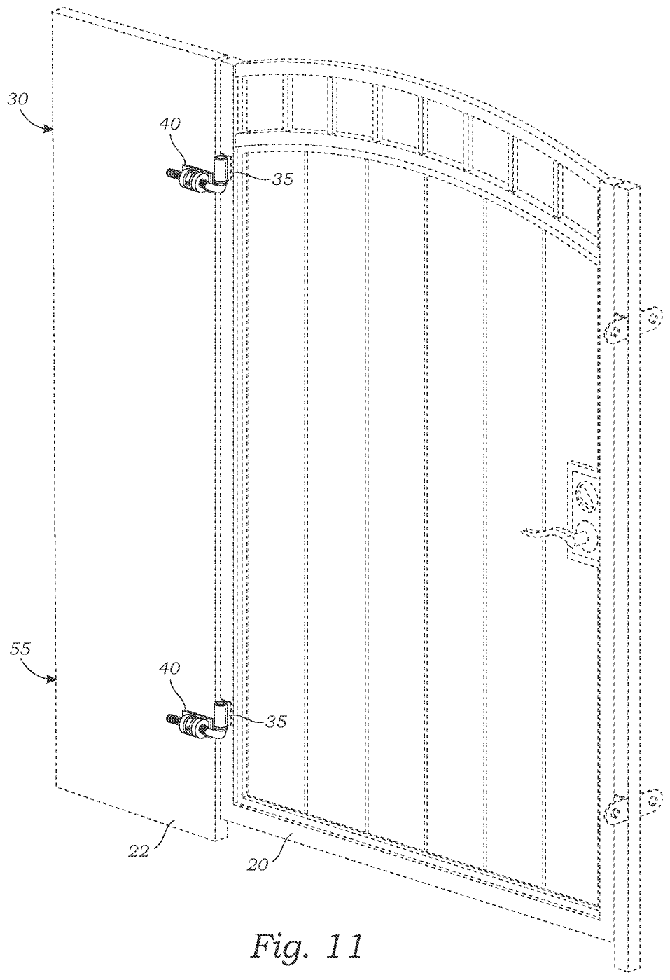

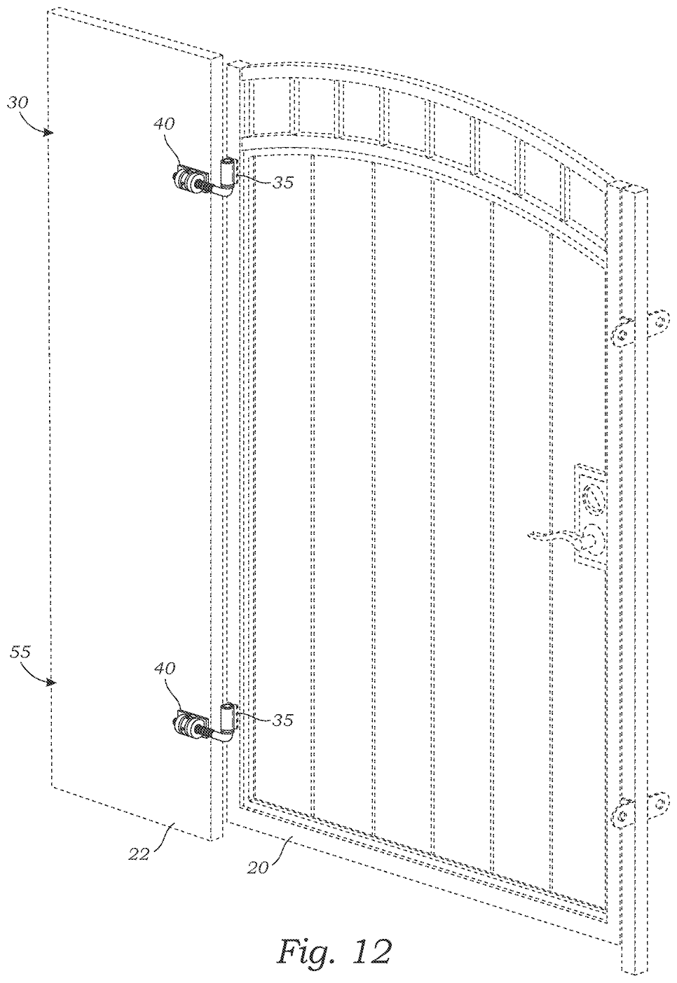

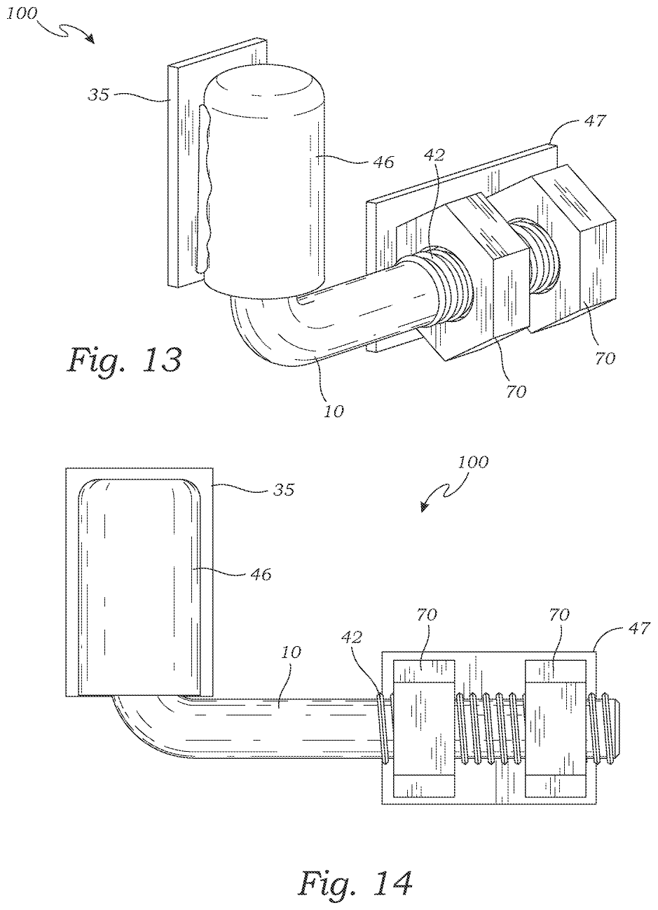

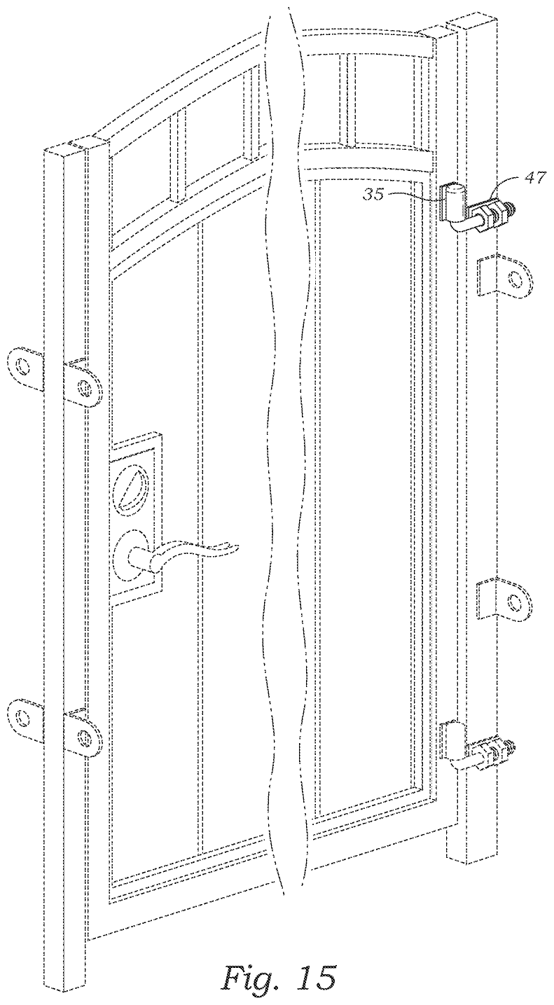

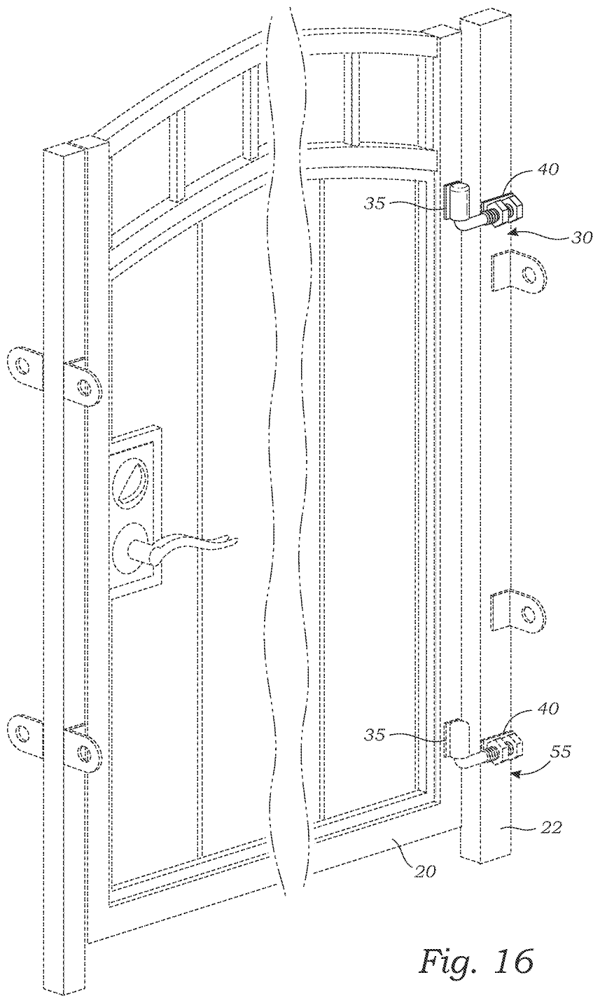

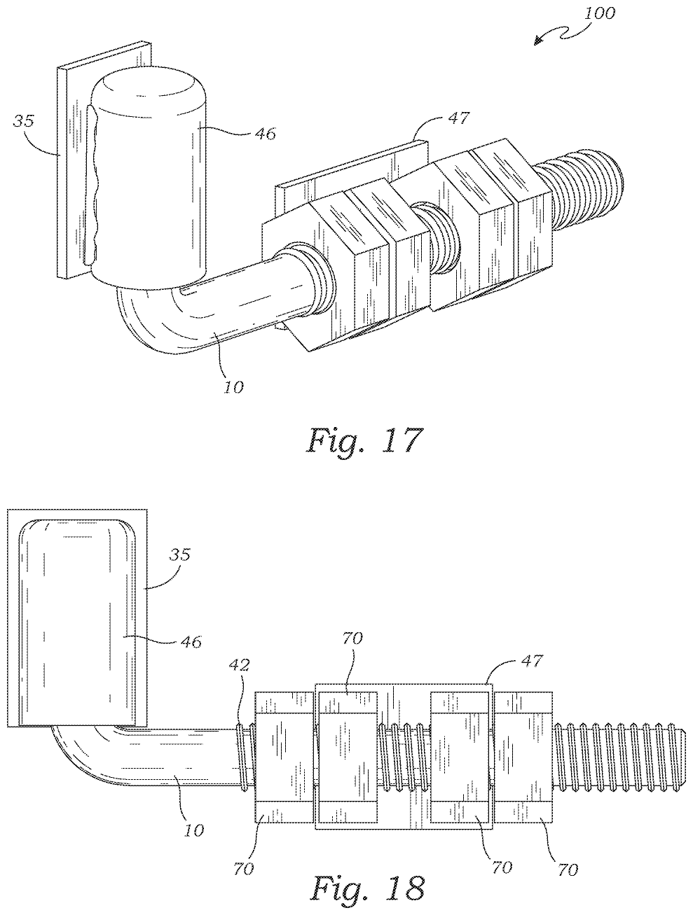

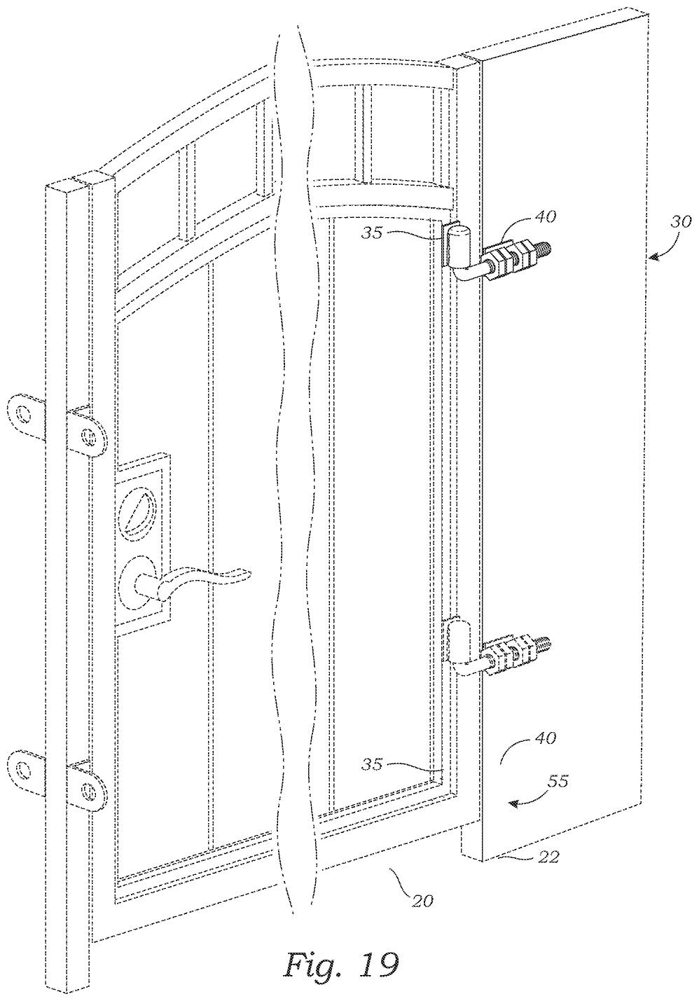

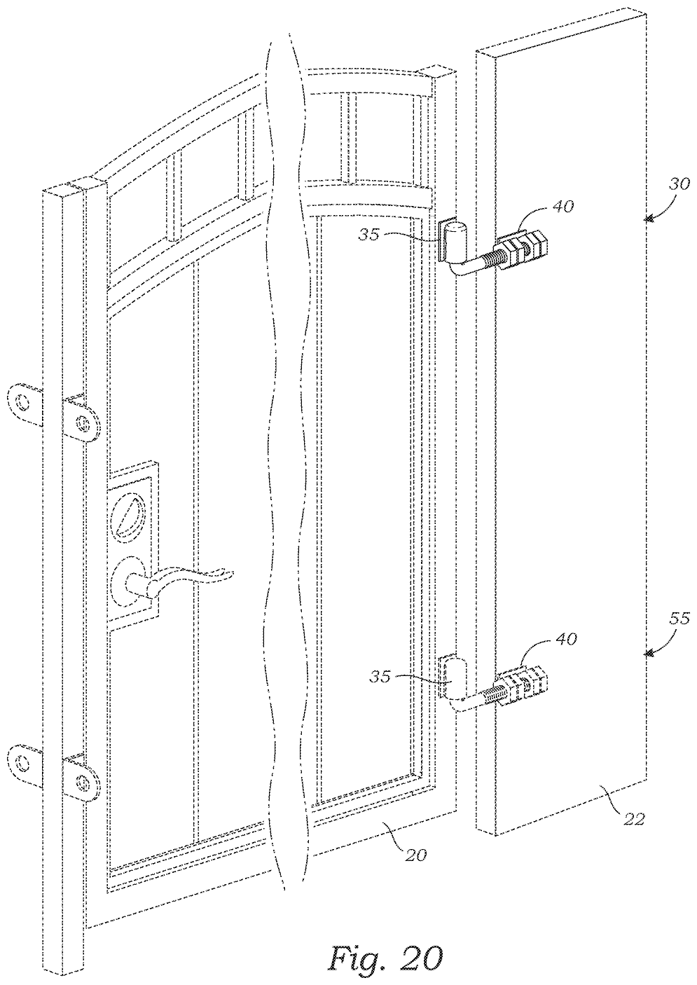

FIGS. 1-6 show the preferred embodiment of the invention having a nut for adjusting said hinge. FIGS. 7-20 show alternative embodiment of the invention for adjusting said hinge.

A gate hinge apparatus (100) adapted to be fastened to a vertical gate (20) and to a post (22), comprising: a first L-bolt (10) having an elongated horizontal portion formed with thread (42) and a transition into a vertical male member (44); a top (30) first bracket (35) having a female mounting flange (46) mounted to either the gate or the post disposed adjacent to the gate as elected by said user; a top (30) second bracket (40) having a plate (47) having one or more threaded means for holding and retaining (48) said L-bolt, which is mounted to the gate (20) or the post (22) disposed adjacent to the gate (20); a second L-bolt (10) having an elongated horizontal portion formed with thread (42) and a transition into a vertical male member (50); a bottom (55) first bracket (35) having a female mounting flange mounted to either the gate or the post disposed adjacent to the gate as elected by said user; a bottom (55) second bracket (40) having a plate (47) having one or more threaded means for holding and retaining (48) said L-bolt, which is mounted to the gate or the post disposed adjacent to the gate; said L-bolt (10) uses its vertical male member (44) to connect to said female mounting flange (46); and said L-bolt (10) has one or more nuts (70) that are positioned on said thread (42) on said elongated horizontal portion of said L-bolt (10) to adjust said hinge (100).

Wherein the first bracket is welded to said female mounting flange of the gate or the post disposed adjacent to the gate.

Wherein the second bracket has a plate that is welded to the gate or the post disposed adjacent to the gate.

Wherein the second bracket has one or more threaded means that are welded for holding and retaining said L-bolt.

Wherein the gap width is adjustable using a wrench to turn the nut; wherein by rotating the nut in a first angular direction to increase the gap width; and wherein by rotating the nut in a second angular direction, opposite of the first angular direction, to decrease the gap width.

Wherein the gap width is adjustable using an Allen wrench to turn the nut; wherein by rotating the nut in a first angular direction to increase the gap width; and wherein by rotating the nut in a second angular direction, opposite of the first angular direction, to decrease the gap width.

A method of adjusting the gap width between the first bracket and the second bracket of the above claims, the method comprising: rotating the nut in a first angular direction to increase the gap width; and rotating the bolt in a second angular direction, opposite of the first angular direction, to decrease the gap width.

A gate hinge apparatus comprising: a first L-bolt (10) having an elongated horizontal portion formed with thread (42) and a transition into a vertical male member (44); a first bracket (35) having a female mounting flange (46) mounted to either the gate or the post disposed adjacent to the gate as elected by said user; a second bracket (40) having a plate (47) having one or more threaded means for holding and retaining (48) said L-bolt, which is mounted to the gate (20) or the post (22) disposed adjacent to the gate (20); said L-bolt (10) uses its vertical male member (44) to connect to said female mounting flange (46); said L-bolt (10) has one or more nuts (70) that are positioned on said thread (42) on said elongated horizontal portion of said L-bolt (10) to adjust said hinge (100); wherein a user can by rotating the nut in a first angular direction to increase the gap width; and wherein said user can by rotating the nut in a second angular direction, opposite of the first angular direction, to decrease the gap width.

A gate hinge apparatus (100) adapted to be fastened to a vertical gate (20) and to a post (22), comprising: a first L-bolt (10) having an elongated horizontal portion formed with thread (42) and a transition into a vertical male member (44); a top (30) first bracket (35) having a female mounting flange (46) mounted to either the gate or the post disposed adjacent to the gate as elected by said user; a top (30) second bracket (40) having a plate (47) having one or more threaded means for holding and retaining (48) said L-bolt, which is mounted to the gate (20) or the post (22) disposed adjacent to the gate (20); a second L-bolt (10) having an elongated horizontal portion formed with thread (42) and a transition into a vertical male member (50); a bottom (50) first bracket (35) having a female mounting flange mounted to either the gate or the post disposed adjacent to the gate as elected by said user; a bottom (50) second bracket (40) having a plate (47) having one or more threaded means for holding and retaining (48) said L-bolt, which is mounted to the gate or the post disposed adjacent to the gate; and said L-bolt (10) uses its vertical male member (44) to connect to said female mounting flange (46).

Further comping said L-bolt (10) having one or more nuts (70) that are positioned on said thread (42) on said elongated horizontal portion of said L-bolt (10) to adjust said hinge (100).

I claim:

1. A gate hinge apparatus (100) adapted to be fastened to a vertical gate (20) and to a post (22), comprising:
a first L-bolt (10) having an elongated horizontal portion formed with thread (42) and a transition into a vertical male member (44);
a top (30) first bracket (35) having a female mounting flange (46) mounted to either the gate or the post disposed adjacent to the gate as elected by said user;
a top (30) second bracket (40) having a plate (47) having one or more threaded means for holding and retaining (48) said L-bolt, which is mounted to the gate (20) or the post (22) disposed adjacent to the gate (20);
a second L-bolt (10) having an elongated horizontal portion formed with thread (42) and a transition into a vertical male member (50);
a bottom (55) first bracket (35) having a female mounting flange (46) mounted to either the gate or the post disposed adjacent to the gate as elected by said user;
a bottom (55) second bracket (40) having a plate (47) having one or more threaded means for holding and retaining (48) said L-bolt, which is mounted to the gate or the post disposed adjacent to the gate;
said L-bolt (10) uses its vertical male member (44) to connect to said female mounting flange (46); and
said L-bolt (10) has one or more nuts (70) that are positioned on said thread (42) on said elongated horizontal portion of said L-bolt (10) to adjust said hinge (100).

2. The gate hinge apparatus of claim 1, wherein the first bracket is welded to said female mounting flange of the gate or the post disposed adjacent to the gate.

3. The gate hinge apparatus of claim 1, wherein the second bracket has a plate that is welded to the gate or the post disposed adjacent to the gate.

4. The gate hinge apparatus of claim 1, wherein the second bracket has one or more threaded means that are welded for holding and retaining said L-bolt.

5. The gate hinge apparatus of claim 1, wherein the first bracket is welded to said female mounting flange to provide connecting means to the gate or the post disposed adjacent to the gate.

6. The gate hinge apparatus of claim 4, wherein the second bracket has one or more nuts that are welded for holding and retaining said L-bolt.

7. The hinge apparatus gate of claim 1, wherein the gap width is adjustable using a wrench to turn the nut; wherein by rotating the nut in a first angular direction to increase the gap width; and wherein by rotating the nut in a second angular direction, opposite of the first angular direction, to decrease the gap width.

8. The gate hinge apparatus of claim 1, wherein the gap width is adjustable using an Allen wrench to turn the nut; wherein by rotating the nut in a first angular direction to increase the gap width; and wherein by rotating the nut in a second angular direction, opposite of the first angular direction, to decrease the gap width.

9. A gate hinge apparatus comprising:
a first L-bolt (10) having an elongated horizontal portion formed with thread (42) and a transition into a vertical male member (44);
a first bracket (35) having a female mounting flange (46) mounted to either the gate or the post disposed adjacent to the gate as elected by said user;
a second bracket (40) having a plate (47) having one or more threaded means for holding and retaining (48) said L-bolt, which is mounted to the gate (20) or the post (22) disposed adjacent to the gate (20);
said L-bolt (10) uses its vertical male member (44) to connect to said female mounting flange (46);
said L-bolt (10) has one or more nuts (70) that are positioned on said thread (42) on said elongated horizontal portion of said L-bolt (10) to adjust said hinge (100);
wherein a user can by rotating the nut in a first angular direction to increase the gap width; and
wherein said user can by rotating the nut in a second angular direction, opposite of the first angular direction, to decrease the gap width.

10. The gate hinge apparatus of claim 1, wherein the first bracket is welded to said female mounting flange of the gate or the post disposed adjacent to the gate.

11. The gate hinge apparatus of claim 1, wherein the second bracket has a plate that is welded to the gate or the post disposed adjacent to the gate.

12. The gate hinge apparatus of claim 1, wherein the second bracket has one or more threaded means that are welded for holding and retaining said L-bolt.

13. The gate hinge apparatus of claim 1, wherein the gap width is adjustable using a wrench to turn the nut; wherein by rotating the nut in a first angular direction to increase the gap width; and wherein by rotating the nut in a second angular direction, opposite of the first angular direction, to decrease the gap width.

14. The gate hinge apparatus of claim 1, wherein the gap width is adjustable using an Allen wrench to turn the nut; wherein by rotating the nut in a first angular direction to increase the gap width; and wherein by rotating the nut in a second angular direction, opposite of the first angular direction, to decrease the gap width.

15. A gate hinge apparatus (100) adapted to be fastened to a vertical gate (20) and to a post (22), comprising:
a first L-bolt (10) having an elongated horizontal portion formed with thread (42) and a transition into a vertical male member (44);
a first bracket (35) having a female mounting flange (46) mounted to either the gate or the post disposed adjacent to the gate as elected by said user;
a second bracket (40) having a plate (47) having one or more threaded means for holding and retaining (48) said L-bolt, which is mounted to the gate (20) or the post (22) disposed adjacent to the gate (20);
said L-bolt (10) uses its vertical male member (44) to connect to said female mounting flange (46).

16. The gate hinge apparatus of claim 16, further comping: a second L-bolt (10) having an elongated horizontal portion formed with thread (42) and a transition into a vertical male member (50); a bottom (55) first bracket (35) having a female mounting flange mounted to either the gate or the post disposed adjacent to the gate as elected by said user; a bottom (55) second bracket (40) having a plate (47) having one or more threaded means for holding and retaining (48) said L-bolt, which is mounted to the gate or the post disposed adjacent to the gate; and said L-bolt (10) uses its vertical male member (44) to connect to said female mounting flange (46).

17. The gate hinge apparatus of claim 16, further comping said L-bolt (10) having one or more nuts (70) that are positioned on said thread (42) on said elongated horizontal portion of said L-bolt (10) to adjust said hinge (100).

18. The gate hinge apparatus of claim 17, wherein the gap width is adjustable using a wrench to turn the nut; wherein by rotating the nut in a first angular direction to increase the gap width; and wherein by rotating the nut in a second angular direction, opposite of the first angular direction, to decrease the gap width.

19. The gate hinge apparatus of claim 17, wherein the gap width is adjustable using an Allen wrench to turn the nut; wherein by rotating the nut in a first angular direction to increase the gap width; and wherein by rotating the nut in a second angular direction, opposite of the first angular direction, to decrease the gap width.

20. A method of adjusting the gap width between the first bracket and the second bracket of claim 15, the method comprising: rotating the nut in a first angular direction to increase the gap width; and rotating the bolt in a second angular direction, opposite of the first angular direction, to decrease the gap width.
